(19) United States
(12) Patent Application Publication
(10) Pub. No.: US 2024/0248984 A1
(43) Pub. Date: Jul. 25, 2024

(54) PROCESS FOR GENERATING OFFENSIVE AND DEFENSE SECURITY DATASET AUGMENTATION WITH INVARIANCE AND DISTRIBUTION INDEPENDENCE

(71) Applicant: Leidos, Inc., Reston, VA (US)

(72) Inventors: Paul F. Roysdon, Boerne, TX (US); Gavin S. Black, Mason, NH (US)

(73) Assignee: Leidos, Inc., Reston, VA (US)

(21) Appl. No.: 18/418,426

(22) Filed: Jan. 22, 2024

Related U.S. Application Data
(60) Provisional application No. 63/481,213, filed on Jan. 24, 2023.

(51) Int. Cl. G06F 21/55; G06N 3/092

(52) U.S. Cl. CPC G06F 21/552; G06N 3/092; G06F 2221/034

(57) ABSTRACT

A process for augmenting network and/or software security-domain data for use in training machine learning (ML) models includes application of one or more augmentation methodologies to existing data sets related to network activities and known attacks. The ML models trained on extended data sets can be implemented in a tool for automating network security defensive training and deployment. Learning attack distributions as opposed to pattern-matching approaches, allows enhanced automation and targeted defenses beyond traditional tools.

### CROSS-REFERENCE TO RELATED APPLICATIONS

The present application claims the benefit of priority to U.S. Provisional Patent Application No. 63/481,213 entitled OFFENSIVE AND DEFENSE SECURITY DATASET AUGMENTATION WITH INVARIANCE AND DISTRIBUTION INDEPENDENCE, filed Jan. 24, 2023, which is incorporated herein by reference in its entirety.

### BACKGROUND

### Field of the Embodiments

The embodiments relate generally to domain specific data augmentation for machine learning (ML) training and specifically to data augmentation methodologies for use in security-focused software and network datasets.

ML models and methods provides key solutions in the classification of network traffic for Quality of Service (QOS), content filtering, lawful interception, and malicious behavior identification purposes. As is well known to ML engineers, at the heart of every ML classifier model is data. Like all ML applications, the success of ML algorithms to software and network applications is driven heavily by the availability and coverage of training data. Ideally, these datasets would be derived from actual network traffic data that represent the targeted application(s). While breakthroughs in the realms of image and text generation have benefitted from the large amount of relevant online sources of information, this is often not the case for service specific security tasks where data may be lacking; especially for uncommon or custom endpoints. Benign daily requests may be plentiful, but reported attacks are not. Relying solely on deviations from baseline traffic leads to alert fatigue, reducing the utility of findings. Furthermore, attackers can either mimic benign traffic or deviate from known distributions to subvert ML-based defenses. These properties violate common distribution assumptions needed to accurately train machine learning (ML) models. This service uniqueness is prevalent throughout many environments resulting in overall difficulty providing security for all network facing data exchanges.

Dataset augmentation is a common method for partially overcoming a lack of samples during training. This process typically involves the application of domain-specific transforms to inputs that preserve the intended classification. Maintaining the relation between the sample and labelling is known as invariance, which is considered particularly challenging in discrete domains. Recent efforts typically create new samples within an initial distribution and assume invariance. For instance, generative artificial networks (GANs) are employed to create data that is statistically similar to the original training corpus. While these techniques are valid, they present practical limitations for security use-cases. They are unable to escape the training distribution and do not provide assurances on the utility of generated samples. Even small changes can drastically alter the intended effect of a request, creating the possibility of shifting the intended classification from the original. Popular methods in natural language processing (NLP), such as backtranslation, are not readily applicable to cases in the security domain. Also, existing techniques do not allow for creation of augmentations in disjointed areas of the solution space, and instead add to the existing structure of the input corpus.

These concepts have not been integrated to enable data augmentations specific to security tasks, especially for offensive contexts. Current methods do not account for invariance that is meaningful for offensive and defensive security tasks. This limits their applicability to real-world use cases and requires large, cultivated datasets to achieve meaningful results.

### SUMMARY OF THE EMBODIMENTS

In first exemplary embodiment herein, a process for augmenting security-domain data for use in training a machine learning (ML) model to classify between benign and malicious requests to a network or application, includes: establishing a first set of security-domain data including known attack data, wherein the first set of security-domain data establish an initial distribution; applying one or more augmentation methodologies to at least a portion of the security-domain data in the first set to establish a second set of security-domain data, wherein at least one of the one or more augmentation methodologies produces data that lie outside of the initial distribution; combining the first and second sets of security-domain data to establish an extended set of security-domain data; and training the machine learning (ML) model using a portion of the extended set of security-domain data.

In second exemplary embodiment herein, at least one non-transitory computer-readable medium storing instructions that, when executed by a computer, perform a process for augmenting security-domain data for use in training a machine learning (ML) model to classify between benign and malicious requests to a network or application, includes: establishing a first set of security-domain data including known attack data, wherein the first set of security-domain data establish an initial distribution; applying one or more augmentation methodologies to at least a portion of the security-domain data in the first set to establish a second set of security-domain data, wherein at least one of the one or more augmentation methodologies produces data that lie outside of the initial distribution; combining the first and second sets of security-domain data to establish an extended set of security-domain data; and training the machine learning (ML) model using a portion of the extended set of security-domain data.

### BRIEF DESCRIPTION OF THE FIGURES

The patent or application file contains at least one drawing executed in color. Copies of this patent or patent application publication with color drawing(s) will be provided by the Office upon request and payment of the necessary fee.

Example embodiments will become more fully understood from the detailed description given herein below and the accompanying drawings, wherein like elements are represented by like reference characters, which are given by way of illustration only and thus are not limitative of the example embodiments herein.

FIG. 1 provides an example of security-specific signals for dataset labeling and shows how these signals work together to inform malicious actors;

FIGS. 2A, 2B, 2C and 2D are exemplary ROC curves for visualizing ML transformer model efficacy between all possible permutations of augmentations and full test sets (consisting of samples from the original data and all augmentation types) in accordance with embodiments herein;

FIG. 3 is a high-dimension visualization of security augmentation distributions (enhanced datasets) in relation to original training data;

FIGS. 4A and 4B are exemplary tool schematics in accordance with an embodiments herein; and

FIG. 5 is a defensive model detection efficacy comparison between ML models trained in accordance with one or more augmentation embodiments and against OTS products.

### DESCRIPTION OF EMBODIMENTS

For network and software security-specific tasks there are two key areas of concern that can be directly tested against. The first of these is detection by a defending product, which covers the broad classes of rules and statistical measures that are used to determine actions to take. Firewalls and their related rulesets are a common example in networking where a request may be blocked or otherwise flagged depending on the content. The other primary consideration is logic preservation; whether the given request induces the same state on the targeted software. For instance, was a new database entry created or a specific response given.

Using these concepts as Boolean signals is therefore straightforward to acquire and allows direct labelling of data either in parallel or batches for training a ML model. Given an initial corpus of data (also interchangeably referred to herein as “original data” or “original dataset”), any form of mutation, change, or generative addition can acquire the correct label via testing and then be incorporated into/added to the original data, producing an augmented dataset/data (also interchangeably referred to herein as “enhanced data”, “enhanced dataset”, “extended data”, “extended dataset” or “variant(s)”). The choice of signal combinations and positive correlations are dependent on the task itself. For direct offensive agents (agents are also interchangeably referred to herein as “ML model(s)” or “model(s)) this is a combined signal where both a negative detection finding, and a positive preservation of logic, are required to indicate success. “Detection” signals determine whether a request is malicious (positive detection) or benign (negative detection). “Preservation” tests if the intended logic is retained after mutation.

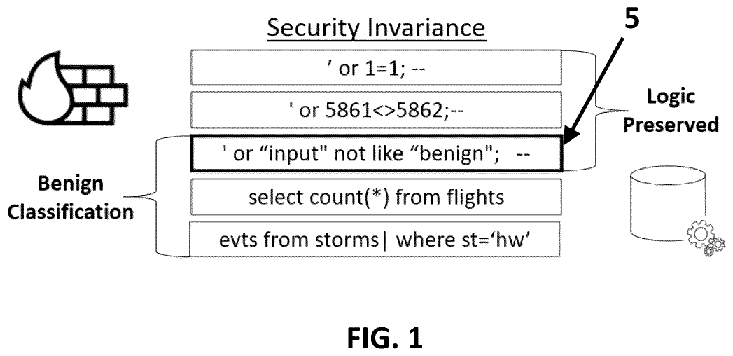

FIG. 1 provides an example of security-specific signals for dataset labeling and shows how these signals work together to inform malicious actors (also interchangeably referred to herein as “malicious request(s)” or “attacker”). Benign Classification corresponds to data samples (samples are also interchangeably referred to herein as “request(s)” or “agent(s)” or “actor(s)” or “query” or “tests”) allowed through defensive ML models. Logic Preserved captures whether the same attack results are produced. An offensive agent is concerned with finding box 5, where logic is maintained (preserved) while also evading detection. An attack is only effective if both: (1) security mechanisms are bypassed, (2) while achieving the same result. This provides a means of labeling any request regardless of the pedigree. Any data sample that meets both conditions satisfies the definition of being malicious and can be used as an augmentation.

These verifiable signals allow for a significant departure from existing methods of generating augmented security data for use in training ML models.

As described herein in detail, different embodiments employ three distinct augmentation techniques derived from NLP augmentation categories for different security-specific interests during training. A first random modification method uses Bayes analysis of an initial data corpus for generating and modifying query structure in a simplified manner. The Bayes method provides traditional augmentation that expands the initial dataset to fill in gaps and increase the boundary while maintaining the same overall manifold structure. Second, domain specific augmentation uses an adversarial method to provide a means for directly analyzing model gradients to produce datasets that have a high chance of producing misclassification. This technique acts as a robustness measure while testing utility of offensive data generated in this manner. Finally, a generative reinforcement learning augmentation shows the use of attack preservation signals and the impact of disjointed dataset additions. Offensive agents cannot assume that the logic is still maintained when changing requests, and defensive agents cannot only consider the class of attacks previously encountered. Reinforcement learning driven dataset variants address both these concerns with the ability to shape the direction of an agent's learning.

All tests are performed using a structured query language (SQL) dataset constructed from publicly available benign and malicious sources. This set was chosen due to the prevalence in web services and continued presence of SQL injections as a top common weakness and related research into mutation strategies and model creation. In an enterprise setting SQL-like queries often traverse the network to either interfaces with database tools or to filter results from data stores. This presents a worst-case scenario for classification of traffic since both malicious and benign queries will fall within similar distributions.

For the embodiments described herein, an SQL engine such as SQLite provides a comprehensive set of samples for database functionality. Pre-built unit samples, i.e., SQL statements (also interchangeably referred to herein as “inquiries” or “entries”), are distributed with the source code and used to support the embodiments herein. These samples are comprised of individual SQL statements that are collected with any duplicates removed, yielding 39,812 unique entries. For malicious samples the payload box collection was chosen from the SQLite library, which includes attacks from multiple sources. These queries span several SQL injection classes based on error conditions, union queries, boolean manipulation, and response timing. Samples of each attack type are provided, totaling 8,657 examples.

For the Bayes analysis random modification augmentation, an enhanced method of augmentation based on corpus analysis is used. This provides a method of extending the solution space with meaningful patterns based on existing data. A procedure similar to that described in, is employed, with modifications, to allow replay and use a single class. The goal is to reduce the set of constructs to those with a high likelihood of maintaining syntactic structures. These changes can be facilitated with a corpus of representative examples. This data can be collected from test cases, network logs, or any other source where requests are available. The set of character tokens is examined for both ordering and adjacency and replayed as a form of augmentation.

Let C be a data corpus composed of individual samples c₁, c₂, . . . cₙ. Each sample is represented by an ordered list of tokens from a vocabulary, V. Selecting a pair of tokens, vᵢ and vⱼ, their adjacency probability is denoted as p(vᵢ∫vⱼ). It should be noted that this is not symmetric and must be computed separately, in both directions. Using Bayes theorem, this is decomposed into sets of operations over a corpus of data, resulting in overall frequencies of occurrence for relevant samples. Then for vᵢ, vⱼ∈c, ∀c∈C,

$$p ( {v}_{i} ≀ {v}_{j} ) = P ( {v}_{i} {v}_{j} \vert {v}_{j} ) = P ( {v}_{i} {v}_{j} ⋂ {v}_{j} ) / P ( {v}_{j} ) . \qquad ( 1 )$$

The vocabulary is updated to include any new constructs that meet a given threshold, ∈=0.1, such that

$${V}^{′} = V ⋃ \{ {v}_{i} {v}_{j} , p ( {v}_{i} ≀ {v}_{j} ) > ϵ \} . \qquad ( 2 )$$

Bayes theorem is used to determine the probability of all instances where vᵢ′ appears anywhere before vⱼ′, with vᵢ′, vⱼ′∈V′. These remain ordered, but are no longer strictly adjacent. The new pairings are used to create updated correlations for each vᵢ′, vⱼ′∈c, ∀c∈C.

The result is a set of paired tokens (vᵢ′, vⱼ′) that appear together at a given frequency and are filtered with a lower bound of ∈. Examining only correlated tokens greatly limits the search space while still maintaining structure of the underlying distribution compared to random mutation. Utilization of correlated characters can be accomplished by treating the input set as a list with Ø surrounding elements. This allows simulating insertions and replacement of tokens via uniform sampling of (vᵢ′, vⱼ′). These selected tokens are injected into the list, and remaining Ø elements removed to create a string.

For domain specific augmentation, a gradient-based distributional attack (GBDA) technique is used to modify SQL requests. The approach creates an adversarial distribution for an input sequence that are similar to benign queries but cause misclassification. This process allows for testing an augmentation technique, because each original input yields many variants.

The technique requires a continuous representation, enabling optimization through gradient descent. Samples are initially discrete, but transformed into a continuous categorical distribution via Gumbel-Softmax reparameterization. This is accomplished by learning parameters Θ∈R^{n'|V|}, where n is the fixed length of sequences and V is the vocabulary of the tokens. Let gᵢ˜Gumbel(0,1) and r be temperature, then the per-token distribution is

$${d}_{i} = \frac{exp ( ( log ( {Θ}_{i} ) + {g}_{i} ) / τ}{{\sum }_{j = 1}^{n} exp ( ( log ( {Θ}_{j} ) + {g}_{j} ) / τ} , i ∈ [ 1 , n ] . \qquad ( 3 )$$

The parameters of Θ are learned via an adversarial loss function. Let k be the minimum margin of desired loss and ϕ be the target model to subvert. The P_{Θ} combined distribution of learned categorical variables, dᵢ, can now be treated as an embedding e. Assuming binary classification, the original label is y and the opposite classification is y̅, the loss function can be defined as

$${min}_{Θ} {𝔼}_{d \sim {P}_{θ}} max ( {ϕ ( e ( d ) )}_{y} - {ϕ ( e ( d ) )}_{\overline{y}} + k , 0 ) . \qquad ( 4 )$$

Eqn. 4 is further constrained by both fluency and similarity constraints. After training, d is the adversarial distribution that is directly sampled. Increasing τ smooths the distribution, creating more diverse samples. This randomness is at the expense of matching the original probability distribution and leads to samples that do not result in misclassification. This technique is used to create the adversarial (Adv) test dataset. Generated samples were scored against a commercial firewall product to assign labels corresponding to “benign” or “malicious”.

An attacker must ensure that logic is maintained after mutation or the result is unusable. A defensive agent cannot only consider small changes to previously encountered malicious requests and must account for variants that significantly diverge. RL-based augmentations address both these concerns and shape the direction of an agent's learning, creating modifications that deviate from initial samples.

RL algorithms learn a policy π, that can be sampled from to maximize total reward. The input is the current state s, at time t, defined as sₜ. After an action aₜ is chosen from policy π, a new state sₜ₊₁ is observed. The goal is to maximize the Bellman equation which yields a reward, rₜ, that is discounted for future steps using a constant γ. Thus,

$${V}^{π} ( {s}_{t} ) = {{𝔼}_{t}}_{{a}_{t} \sim π} [ {r}_{t} + γ {V}^{π} ( {s}_{t + 1} ) ] . \qquad ( 5 )$$

To learn π, we must define the action space, states, and rewards. Actions correspond to mutations from Table 1 below (from L. Demetrio et al., WAF-A-MoLE: Evading Web Application Firewalls through Adversarial Machine Learning, arXiv:2001.01952v1 [cs.CR] 7 Jan. 2020, incorporated herein by reference in its entirety) plus “reset” and “submit”. At submission, the overall mutation receives a value for r, based on the following components: preservation for maintaining attack logic; change types count of unique modification classes; and total for the overall number of mutations.

TABLE 1

| Operator | Short definition | Example |
|---|---|---|
| Case | CS(. . . a . . . B . . .) → . . . | CS(admin′ OR 1 = |
| Swapping | A . . . b . . . | 1#) → ADmIn′ oR |
| | | 1 = 1# |
| Whitespace | WS(. . . k₁k₂ . . .) → . . . | WS(admin′ OR 1 = |
| Substitution | k₁ [symbol] k₂ . . . | 1#) → admin′\n |
| | | OR \t 1 = 1# |
| Comment | C [symbol] (. . . k₁k₂ . . .) → . . . | C [symbol] (admin′ OR |
| Injection | k₁/**/k₂ . . . | 1 = 1#) → admin′/**/ |
| | | OR 1 = 1# |
| Comment | CR(. . . /*s₀*/ . . .#s₁) → . . . / | CR(admin′/**/OR 1 = |
| Rewriting | *s′₀*/ . . .#s′₁ | 1#) → admin′/*abc*/ |
| | | OR 1 = 1#xyz |
| Integer | IE(. . . n . . .) → . . . | IE(admin′ OR 1 = |
| Encoding | [symbol] x[n]₁₆ | 1#) → admin′ OR 0 × |
| | | 1 = 1# |
| Operator | OS(. . . ⊕ . . .) → . . . | OS(admin′ OR 1 = |
| Swapping | [symbol] . . . (with ⊕ [symbol] ) | 1#) → admin′ OR |
| | | 1 LIKE 1# |
| Logical | LI(. . . e . . .) → . . . | LI(admin′ OR 1 = |
| Invariant | e AND [symbol] . . . | 1#) → admin′ OR |
| | | 1 = 1 AND 2 <> 3# |

[symbol]

indicates data missing or illegible when filed

These ensure the request is not mutated in such a way that invalidates usage, while favoring overall complexity. Total number of mutations are limited; negative rewards are given when logic checks fail, or a fixed step limit is exceeded.

The state space, s, is a combination of the potential rewards and request tokens. The mutation agent can observe the number of steps taken, the logic preservation, and present mutation strategies. The mutation agent then finds independent samples that can significantly deviate from the original example. This is similar to a traditional fuzzing process where initial inputs are mutated into new variants to discover branches of program logic.

Systematic methods of determining the success of an augmentation are required to provide a meaningful evaluation. Since there is no widely accepted theoretical basis for measuring general data augmentation success, this limits findings to demonstrating improvements on downstream model tasks. For security related uses, in most cases, this task is ultimately classification. A defensive system must determine if a request is benign and offensive tools must guarantee an attack succeeded. This assumption allows for simplification of measuring augmentation utility by measuring the predictive ability of binary classifiers trained with the enhanced datasets.

Multiple numerical metrics exist for determining the overall utility of a binary classifier. One predominant method is an F1 score which has high sensitivity to precision and recall. This score provides a quantitative metric for the degree of error in classification tasks that is also applicable in cases of class imbalance. Another common method of measuring overall improvement for ML models is the use of receiver operator characteristic (ROC) curves and related area under the curve (AUC) measurements. This score provides a measure of the true positive rate compared to the false positive rate over varying thresholds. F1 scores are sensitive to dataset skew in one direction, whereas AUC scores are not impacted directly but likely obscure details of misclassification. This allows for finding areas where differences between positive and negative samples have a large impact as well as categorizing overall classifier behavior.

During experimentation, wherein the above-identified augmentations were applied, we collected classification results data to provide quantitative and qualitative metrics. Numerical results are based on downstream classification task accuracy for estimating existing firewall rules. The visual projections use the encoded input layers to demonstrate dataset overlap and estimate coverage.

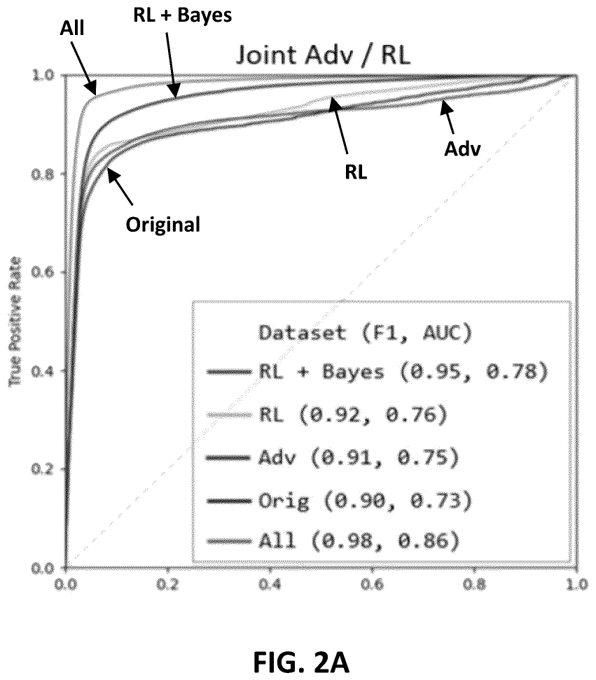

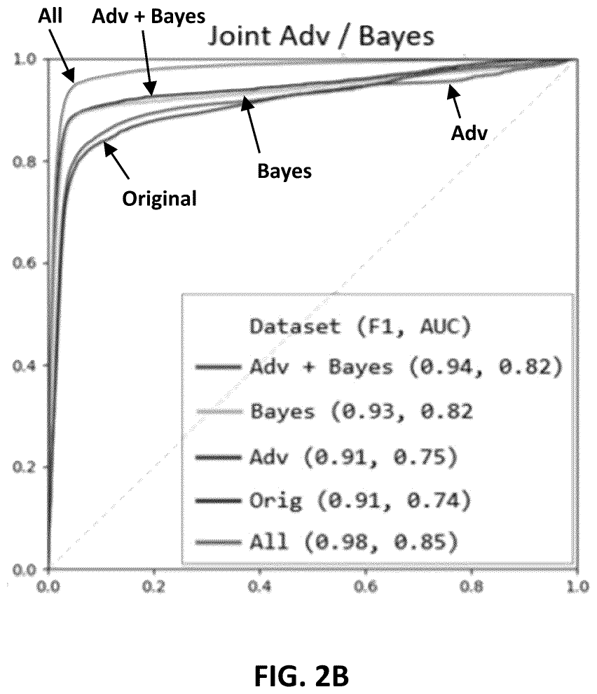

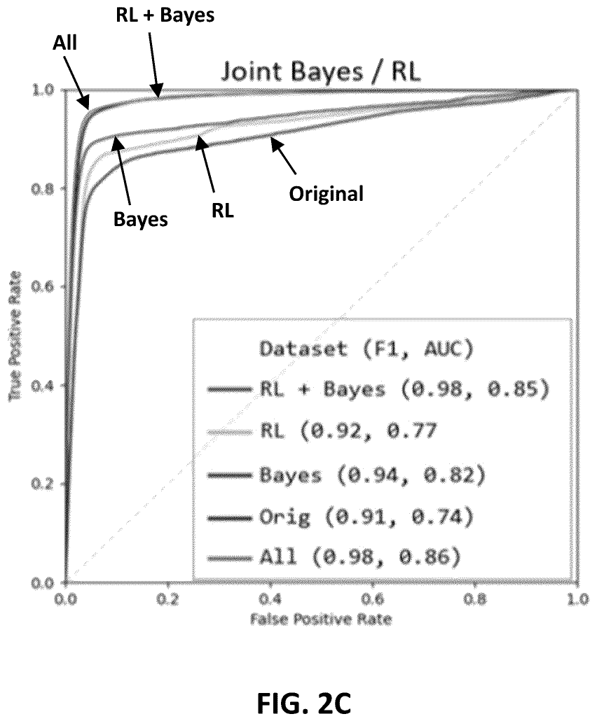

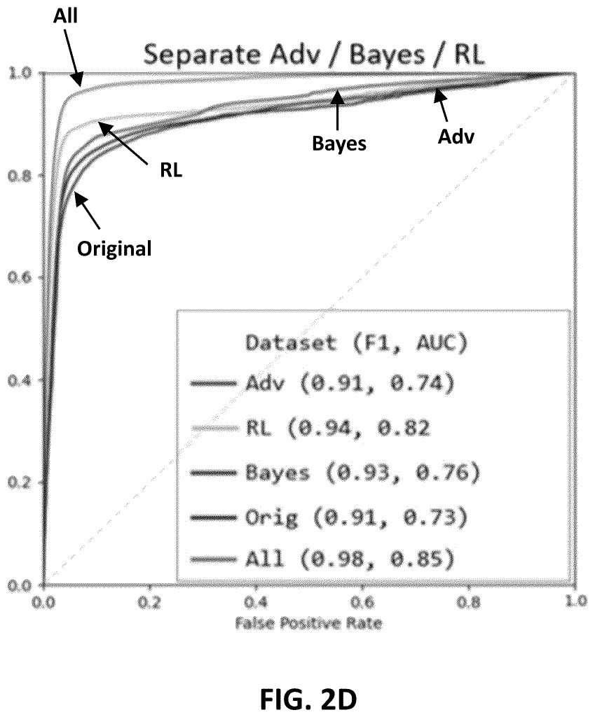

Multiple tests were run utilizing the described models, scoring, and augmentations. These trials consisted of the same datasets shuffled and split into different training, validation, and test sets. This was performed five times for each entry and averaged for any repeated test. The character-based transformer model was used for the full range of comparisons between all possible permutations of augmentations and full test sets (consisting of samples from the original data and all augmentation types). During these tests, ROC curves were retained for visual inspection as exemplified in FIGS. 2A, 2B, 2C and 2D.

The same trials were run for each possible test set. This includes isolated samples from the Bayes, RL, and adversarial augmentations, as well as the non-augmented original samples. The use of F1 and AUC scores on generated data is used to show where security augmentations provided benefit and potential gaps in defensive training. These scores are based on combinations of different augmentations with certain portions removed. Table 2 shows scores for all transformer-based trials. Contributions of each augmentation and their resulting metrics are captured. Bold scores represent entries that achieved the highest F1 values for a given test. The RL and Bayes sets together provided the necessary coverage to accurately classify all augmentation types. On their own, each contribute a notable improvement in scores. Neither achieve the same performance as their combined set, showing that both methods are useful for security classification tasks. The adversarial model in this case conferred limited advantage but does show the ability to cause significant misclassifications.

TABLE 2

| | All | | Bayes | | Adv | | RL | | Orig | |
|---|---|---|---|---|---|---|---|---|---|---|
| | AUC | F1 | AUC | F1 | AUC | F1 | AUC | F1 | AUC | F1 |
| Bayes | 0.94 | 0.82 | 0.98 | 0.86 | 0.88 | 0.50 | 0.47 | 0.00 | 0.99 | 0.94 |
| Adv | 0.91 | 0.75 | 0.96 | 0.79 | 0.90 | 0.52 | 0.47 | 0.00 | 0.98 | 0.92 |
| RL | 0.93 | 0.76 | 0.93 | 0.77 | 0.81 | 0.45 | 0.96 | 0.84 | 0.97 | 0.93 |
| Bayes + Adv | 0.94 | 0.82 | 0.98 | 0.87 | 0.91 | 0.56 | 0.44 | 0.00 | 0.99 | 0.95 |
| RL + Bayes | 0.98 | 0.85 | 0.98 | 0.85 | 0.86 | 0.47 | 0.98 | 0.92 | 0.99 | 0.94 |
| Adv + RL | 0.94 | 0.78 | 0.95 | 0.78 | 0.90 | 0.52 | 0.97 | 0.92 | 0.98 | 0.92 |
| Original | 0.91 | 0.74 | 0.95 | 0.77 | 0.84 | 0.50 | 0.48 | 0.00 | 0.98 | 0.94 |
| All | 0.98 | 0.86 | 0.98 | 0.86 | 0.91 | 0.55 | 0.98 | 0.94 | 0.99 | 0.95 |

In every case, the combination of all augmentations always displayed improved performance. If multiple augmentations are available and there is no reasonable method or time for ablation studies, then the inclusion of all possible sample mutations is not a detriment. The primary penalty is increased training time due to learning on unneeded examples.

The adversarial set demonstrates low precision and recall compared to other test sets. A corresponding high false negative rate of 0.45 was observed, showing the ability of the adversarial method to allow malicious examples to remain undetected. The false positive rate was 0.04, because samples that were benign did not result in detections.

The RL set is of interest due to the inability of some training sets to achieve significant precision or recall. This is due to a lack of positive (“blocked”) predictions which lead to zero true positives and an F1 score of zero. The drop in classification scores is caused by violation of identical distribution (ID) assumptions by the RL-generated data.

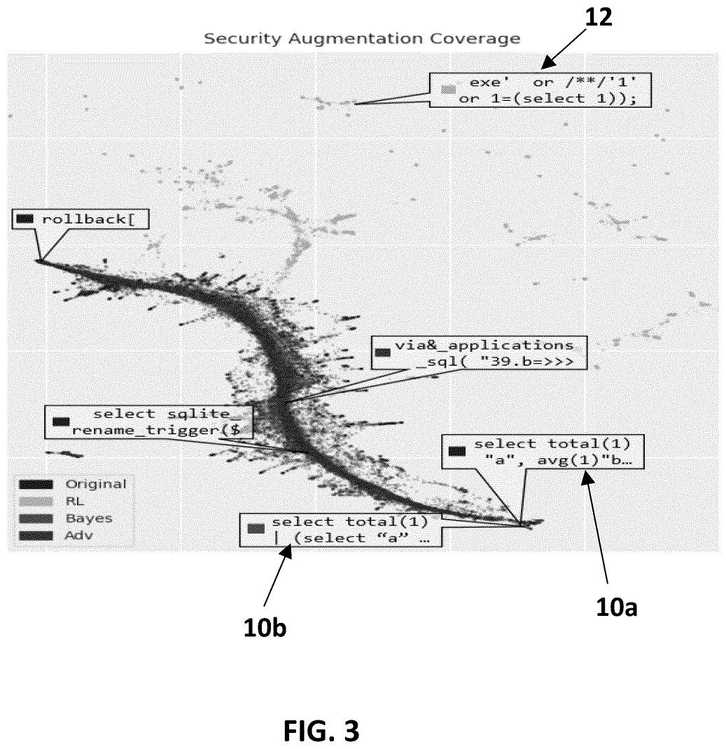

FIG. 3 is a high-dimension visualization of security augmentation distributions (enhanced datasets) in relation to original training data providing a rationale for augmentation performance. The Pairwise Controlled Manifold Approximation technique was employed due to the ability to maintain structure beyond other similar algorithms. An initial principal component analysis (PCA) is performed to create a 100-dimensional set of features that are then sorted into sets of points that are near, mid-near, and far using iterative attractive and repulsive forces. These properties are preserved in the lower dimensional space to produce a simplified low-order projection of the dataset. The raw character space was used to examine overlapping and disjointed sample points and show coverage of the different methodologies. The findings show the Bayes method (Green) extending the initial (original) set, indicating utility as a standard augmentation method. The adversarial technique set (Purple) lies within the initial corpus, conferring little new coverage. And the reinforcement learning model (Yellow) produces data points disjointed from the original training data, requiring the augmented set to adequately classify the samples.

Further to FIG. 3, the Bayes method extends the existing entries further. For instance, an original sample starting with [select total(1) “a”] 10ₐ may be modified to [select total(1)|] 10_{b}. This minor change does not significantly impact the location of a mutated sample. The increased coverage allows models to train on nearby samples but is limited to the initial distribution. An entry that uses different request syntax, but preserves logic, would not be detected.

The adversarial samples are created using the GBDA algorithm as described above. This technique creates minimal changes to an initial sample, with a goal of causing an opposite classification. The resulting variants then have heavy overlap with the original data and do not extend coverage. Since these samples are inliers of the original distribution, they do not provide a particularly useful augmentation.

RL changes were allowed to be significantly different due to the inclusion of a preservation signal as described above. This created deviations with little overlap between the original set. A sample such as [exe′ or /*aF12la9E*/‘1’ or 1=(select 1))] 12; differs from the initial [′OR 1=1]; even though both represent identical logic. The other tested augmentations, Bayes and adversarial, have a direct relation to the initial token distribution, whereas the RL entries are not ID. These out-of-distribution (non-ID) changes resulted in notably worse scores for any tests without relevant RL augmentations. A key limitation is the availability of appropriate environments that can efficiently explore the larger solution space.

These findings show the limitation of ID assumptions for classifiers in security domains. An attacker only needs to find a non-ID permutation to evade classifiers trained to detect known attack patterns. Conversely, benign distributions can be imitated with adversarial techniques which limits efficacy of anomaly-detection based defenses.

The efficacy of ML-based defenses (learned defensive models) relies on understanding both the learned distributions and their interconnections. This is fundamentally different from signature or direct anomaly detection. Expanding domains using Bayes and similar methods is simple but susceptible to attackers manipulating syntax to avoid detection. Anomaly detection can recognize such alterations but may result in excessive alerts. Conversely, RL augmentation identifies new distributions through preservation signals, an approach inapplicable in non-security contexts.

The embodiments and analyses described herein demonstrate the feasibility of creating augmentations that maintain invariance to address identified challenges. Unlike augmentation in other sequence-based domains, supervised training labels are readily preserved through software signals. This enables the expansion of current coverage areas and the exploration of independent solutions that enhance robustness.

The expanded sets of samples generated by the augmentation methods described above are directly measured for increased downstream task precision and recall. Both Bayes-based sampling and RL-driven changes showed significant classification improvements in all cases. The RL method was able to break ID assumptions, leading to diverging samples with the same logic.

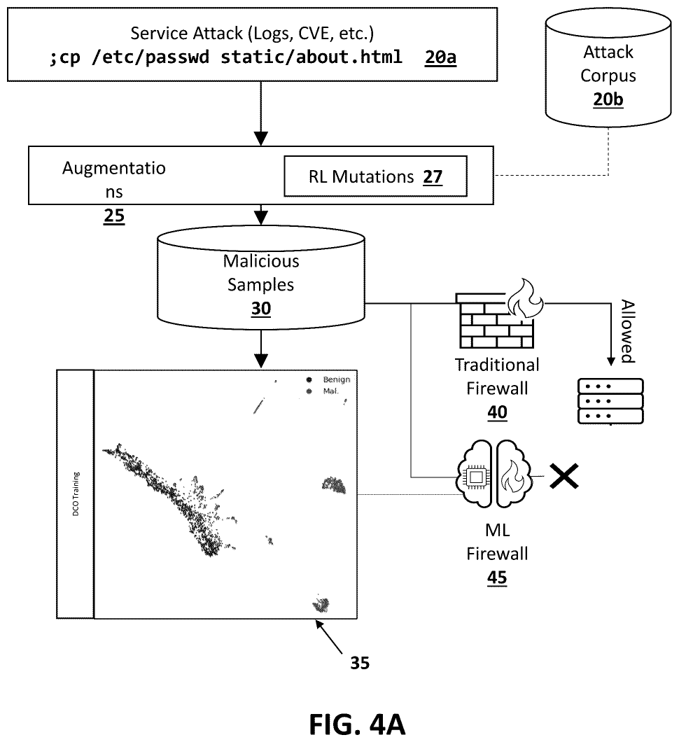

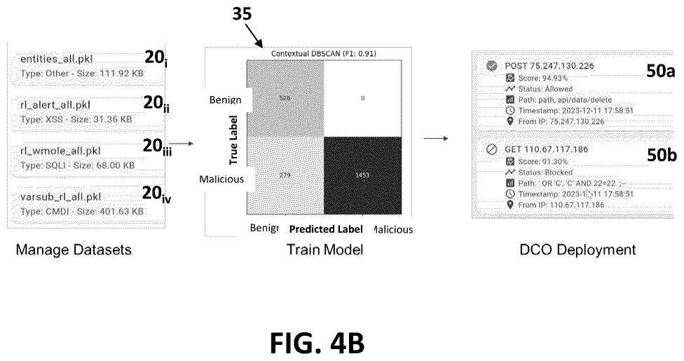

The security-domain data augmentation methodologies discussed herein can be implemented in a tool for automating network security defensive training and deployment. Learning attack distributions as opposed to pattern-matching approaches, allows enhanced automation and targeted defenses beyond traditional tools. Referring to FIG. 4A, one such exemplary tool takes in datasets from multiple sources 20a, 20b related to network activity or known attacks, e.g., SQLI (SQL Injection), XSS (Cross-Site Scripting), CMDI (Command Injection). These datasets are augmented 25, as needed, and saved for later model training 30. Datasets may be subject to one or more of the augmentation methods described above, including RL Mutation 27. Next, transformer-based ML models, e.g., DBSCAN, LogBERT, trained on the expanded datasets, are used to examine the requests and determine if there is a match with a learned distribution 35. By way of example, contextual embedding from the transformer create distances suitable for DBSCAN clustering. Malicious samples that are allowed by a traditional firewall 40, are blocked by the ML firewall 45 due to the improved training with enhanced dataset containing original plus augmented data sets.

In FIG. 4B, an alternative, high-level schematic of the tool provides some specific, exemplary managed datasets which are expanded training datasets 20i, 20ii, 20iii and 20iv including augmented data as described above. An ML transformer model 35 is trained. When deployed, the model correctly identifies and allows benign requests 50a and blocks malicious requests 50b, with a high degree of accuracy.

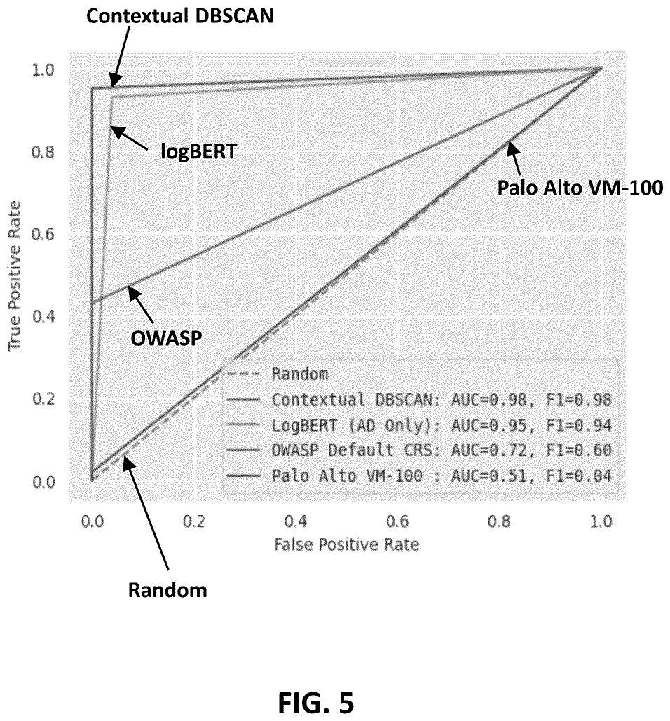

Comparing these defensive model products against common OTS products, such as OWASP and Palo Alto, shows detection improvements. FIG. 5 shows where other OTS products are unable to adapt, with the Palo Alto performing close to a random classifier and the default settings for OWASPs Core Rule Set performing better, but still allowing a significant number of attacks. Whereas our tested transformer models, Contextual DBSCAN and LogBERT (AD Only) were able to learn and defend against the attacking distribution.

Described herein are processes for creating changes to malicious network requests with quantifiable statistical variance and the use of that data to train defensive classifiers. Key features of the processes and resulting implementing tools include:
An improved method for security dataset augmentations that maintain detection invariance
An improved method for creating variations of observed attacks for model training
An improved method for generating models that emulate a target product's behavior
Improved methods to determine if an augmentation has provided additional security coverage both qualitatively and quantitively
An improved method for inducing faults in trained classification models

There are numerous applications for the techniques and tools described herein across multiple offensive and defensive security tasks. The following is a non-exclusive list of security applications which may be achieved and enhances with application of one or more embodiments described herein.
Purple team testing of uncommon endpoints with minimal initial data
Automated offensive tooling with coverage and logic preservation guarantees
Statistical attack signatures to detect variants of known malicious activity
Offline representations of existing defensive products for offensive testing and training
Alert and detection testing and configuration for Security information and event management (SIEMs)
Fingerprinting of detected traffic patterns, both benign and malicious
Evaluation of defensive machine learning product susceptibility to adversarial data

It is submitted that one skilled in the art would understand the various computing environments, including computer readable mediums, which may be used to implement the methods described herein. Selection of computing environment and individual components may be determined in accordance with memory requirements, processing requirements, security requirements and the like. It is submitted that one or more steps or combinations of step of the methods described herein may be developed locally or remotely, i.e., on a remote physical computer or virtual machine (VM). Virtual machines may be hosted on cloud-based IaaS platforms such as Amazon Web Services (AWS) and Google Cloud Platform (GCP), which are configurable in accordance memory, processing, and data storage requirements. One skilled in the art further recognizes that physical and/or virtual machines may be servers, either stand-alone or distributed. Distributed environments many include coordination software such as Spark, Hadoop, and the like. For additional description of exemplary programming languages, development software and platforms and computing environments which may be considered to implement one or more of the features, components and methods described herein, the following articles are referenced and incorporated herein by reference in their entirety: Python vs R for Artificial Intelligence, Machine Learning, and Data Science; Production vs Development Artificial Intelligence and Machine Learning; Advanced Analytics Packages, Frameworks, and Platforms by Scenario or Task by Alex Cistrons of InnoArchiTech, published online by O'Reilly Media, Copyright InnoArchiTech LLC 2020.

The present specification is directed towards multiple embodiments. The disclosure is provided in order to enable a person having ordinary skill in the art to practice the embodiments. Language used in this specification should not be interpreted as a general disavowal of any one specific embodiment or used to limit the claims beyond the meaning of the terms used therein. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present embodiments.

The words “comprising,” “having,” “containing,” and “including,” and other forms thereof, are intended to be equivalent in meaning and be open-ended in that an item or items following any one of these words is not meant to be an exhaustive listing of such item or items, or meant to be limited to only the listed item or items. It should be noted herein that any feature or component described in association with a specific embodiment may be used and implemented with any other embodiment unless clearly indicated otherwise.

While the aspects described herein have been described in conjunction with the example aspects outlined above, various alternatives, modifications, variations, improvements, and/or substantial equivalents, whether known or that are or may be presently unforeseen, may become apparent to those having at least ordinary skill in the art. Accordingly, the example aspects, as set forth above, are intended to be illustrative, not limiting. Various changes may be made without departing from the spirit and scope of the disclosure. Therefore, the disclosure is intended to embrace all known or later-developed alternatives, modifications, variations, improvements, and/or substantial equivalents.

Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” All structural and functional equivalents to the elements of the various aspects described throughout this disclosure that are known or later come to be known to those of ordinary skill in the art are expressly incorporated herein by reference and are intended to be encompassed by the claims.

We claim:

1. A process for augmenting security-domain data for use in training a machine learning (ML) model to classify between benign and malicious requests to a network or application, comprising:
establishing a first set of security-domain data including known attack data, wherein the first set of security-domain data establish an initial distribution;
applying one or more augmentation methodologies to at least a portion of the security-domain data in the first set to establish a second set of security-domain data, wherein at least one of the one or more augmentation methodologies produces data that lie outside of the initial distribution;
combining the first and second sets of security-domain data to establish an extended set of security-domain data; and
training the machine learning (ML) model using a portion of the extended set of security-domain data.

2. The process according to claim 1, wherein the at least one of the one or more augmentation methodologies that produces data outside of the initial distribution that preserves logic of the known attack data.

3. The process according to claim 2, wherein the at least one of the one or more augmentation methodologies that produces data outside of the initial distribution and preserves logic of the known attack data is a reinforced learning (RL)-based augmentation methodology.

4. The process according to claim 1, wherein the at least one of the one or more augmentation methodologies produces data that lie within the initial distribution.

5. The process according to claim 4, wherein the at least one of the one or more augmentation methodologies that produces data that lie within the initial distribution is a random modification augmentation.

6. The process according to claim 5, wherein the random modification augmentation is a Bayesian-based augmentation methodology.

7. The process according to claim 1, wherein the attack data is in a format selected from the following group consisting of SQLI (SQL Injection), XSS (Cross-Site Scripting), and CMDI (Command Injection).

8. At least one non-transitory computer-readable medium storing instructions that, when executed by a computer, perform a process for augmenting security-domain data for use in training a machine learning (ML) model to classify between benign and malicious incoming requests to a network or application, the process comprising:
establishing a first set of security-domain data including known attack data, wherein the first set of security-domain data establish an initial distribution;
applying one or more augmentation methodologies to at least a portion of the security-domain data in the first set to establish a second set of security-domain data, wherein at least one of the one or more augmentation methodologies produces data that lie outside of the initial distribution;
combining the first and second sets of security-domain data to establish an extended set of security-domain data; and
training the machine learning (ML) model using a portion of the extended set of security-domain data.

9. The at least one non-transitory computer-readable medium according to claim 8, the process further comprising: wherein the at least one of the one or more augmentation methodologies that produces data outside of the initial distribution that preserves logic of the known attack data.

10. The at least one non-transitory computer-readable medium according to claim 9, the process further comprising: wherein the at least one of the one or more augmentation methodologies that produces data outside of the initial distribution and preserves logic of the known attack data is a reinforced learning (RL)-based augmentation methodology.

11. The at least one non-transitory computer-readable medium according to claim 8, the process further comprising: wherein the at least one of the one or more augmentation methodologies produces data that lie within the initial distribution.

12. The at least one non-transitory computer-readable medium according to claim 11, the process further comprising: wherein the at least one of the one or more augmentation methodologies that produces data that lie within the initial distribution is a random modification augmentation.

13. The at least one non-transitory computer-readable medium according to claim 12, the process further comprising: wherein the random modification augmentation is a Bayesian-based augmentation methodology.
